(19) United States
(12) Patent Application Publication
(10) Pub. No.: US 2024/0112053 A1
(43) Pub. Date: Apr. 4, 2024

(54) DETERMINATION OF AN OUTLIER SCORE USING EXTREME VALUE THEORY (EVT)

(71) Applicant: Microsoft Technology Licensing, LLC, Redmond, WA (US)

(72) Inventors: Laurent BOUE, Petah Tikva (IL); Kiran RAMA, Bangalore (IN)

(21) Appl. No.: 17/937,767

(22) Filed: Oct. 3, 2022

(51) Int. Cl. G06N 7/00; G06K 9/62

(52) U.S. Cl. CPC G06N 7/005; G06K 9/6256; G06K 9/6284

(57) ABSTRACT

A subset of data that includes a feature may be selected from a dataset. Parameters from the selected subset of data are determined and an extreme value theory (EVT) algorithm is implemented to determine a probability value for the feature based at least in part on the determined parameters. Based on the determined probability value for the feature, an outlier score is generated for the feature. Based on the outlier score being above a threshold, the subset is identified as anomalous.

### BACKGROUND

Engineering systems, including virtual storage, virtual networking, network streaming, Internet of Things (IoT) devices, software as a service (SaaS), and so forth, continuously produce numerous metrics. While the values of the metrics are within expected standard distributions, deviations and unusual variations in the metrics are identified as outliers and may be indicative of anomalies in the data. Current methods of determining an anomaly score, such as a histogram-based outlier score (HBOS), group features of data samples into bins, generate a histogram based on the bin heights, and identify outliers based on a calculated density of each bin. However, this method can result in inaccuracies due to the same outlier score being assigned to each value in the bin, despite discrepancies in the size and range of the bins to accommodate each selected value.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Examples and implementations disclosed herein are directed to systems and methods that use extreme value theory (EVT) to determine one or more anomalous features in a dataset. For example, the method includes receiving a dataset, selecting a subset of data from the dataset, the subset including a feature, determining parameters of the selected subset of data, implementing an extreme value theory (EVT) algorithm to determine a probability value for the feature based at least in part on the determined parameters, in response to identifying the feature as anomalous, generating an outlier score for the feature, and identifying the subset as anomalous based at least in part on the generated outlier score for the feature.

### BRIEF DESCRIPTION OF THE DRAWINGS

The present description will be better understood from the following detailed description read in light of the accompanying drawings, wherein:

FIG. 1 is a block diagram illustrating an example computing device for implementing various examples of the present disclosure;

FIG. 2 is a block diagram illustrating an example system for implementing various examples of the present disclosure;

FIG. 3 is a flow chart illustrating a computer-implemented method of defining an outlier score according to various examples of the present disclosure; and

FIG. 4 is a flow chart illustrating a computer-implemented method of defining an outlier score according to various examples of the present disclosure.

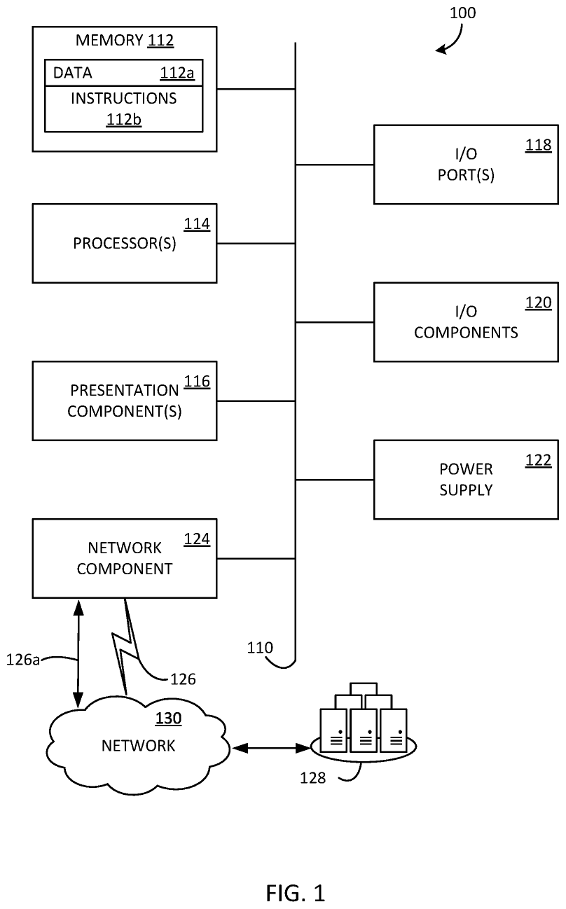

Corresponding reference characters indicate corresponding parts throughout the drawings. In FIGS. 1 to 4, the systems are illustrated as schematic drawings. The drawings may not be to scale.

### DETAILED DESCRIPTION

The various implementations and examples will be described in detail with reference to the accompanying drawings. Wherever possible, the same reference numbers will be used throughout the drawings to refer to the same or like parts. References made throughout this disclosure relating to specific examples and implementations are provided solely for illustrative purposes but, unless indicated to the contrary, are not meant to limit all examples.

Engineering systems continuously produce, or receive, numerous metrics based on the particular system. For example, a virtual storage system generates metrics related to throughput, bandwidth, writes per second, latency, and so forth of the physical hard drives that form a part of the virtual storage system. As another example, an IoT device outputs information regarding an on/off state of edge devices, the gateways, and other information specific to the edge devices. Due to the overwhelming quantity of the metrics and the fact that these metrics are often generated and analyzed in real-time, methods of identifying anomalies in the metrics are complex but essential.

Current methods of detecting anomalies may implement HBOS, which groups different features of a data set into different bins, generates a histogram of the data based on the heights of each bin, and uses the histogram to identify outliers based on the density of each bin. For example, a more dense bin in the histogram indicates the features of the dataset in that bin are more common events and similar to other features in the dataset, which indicates those features are less likely to be anomalies, or outliers. In contrast, a less dense bin in the histogram indicates the features of the dataset in that bin are less common events and less similar to other features in the dataset, which indicates those features are more likely to be anomalies, or outliers. However, this method introduces inaccuracies in the anomaly scores due to the restrictions of the binning method for the features. For example, rare events generally require a bin that would otherwise not include the event to be widened so that the event has a bin to be placed into and to group a sufficiently large number of samples in order for the density to be estimated. Particularly in bins that have been widened, or enlarged, samples that fall on one end of the bin may have values that are very different from samples that fall on the other end of the bin. However, because of the restrictions with the binning infrastructure, all samples in the bin are assigned the same outlier value. Depending on the data, this may cause some outliers to be miscalculated with a lower outlier score than they otherwise should have, or to be miscalculated with a higher outlier score than they otherwise should have.

Accordingly, examples of the present disclosure provide systems and methods that detect anomalies, or outliers, by determining an outlier score for each individual value, rather than determining an outlier score for a bin and then assigning the determined outlier score to each value in the bin. The outlier score for each individual value is determined by implementing extreme value theory (EVT) to learn parameters of a subset of the data, calculate a probability value for each feature in the subset, calculate a threshold for the subset of the data, and calculate a risk factor score for each feature based on the probability value of the respective value relative to the threshold. By leveraging EVT to calculate a risk factor score for each feature individually, the accuracy of identifying outliers is increased and the amount of processing resources required to identify outliers is reduced due to the bins and histograms no longer being needed, without sacrificing the speed at which outliers may be identified.

Upon identification of an anomaly in the dataset, an action may be triggered. The specific action is dependent upon various factors, including the engineering system executing the systems and methods. For example, an engineering system for one or more IoT devices that detects an anomaly in an IoT device may indicate that a particular device has failed or is susceptible to failing. The triggered action for this scenario may be to repair or replace the failed device. In another example, an engineering system that performs virtual computing for a payment system may detect an anomaly indicating an order of an unusual size or from an unusual account. The triggered action for this scenario may be to flag the order as potentially fraudulent and either decline to process the order or investigate the order prior to fulfillment. However, these examples are presented for illustration only and should not be construed as limiting. The systems and methods presented herein may be executed by any type of engineering system triggering a particular action without departing from the scope of the present disclosure.

As referenced herein, EVT refers to a branch of mathematics that focuses on the statistics of extreme events, such as the behavior of the maximum and/or minimum, of random variables. Given a defined risk factor q, the EVT may be leveraged to extract a threshold z such that the probability of any sample s to exceed the threshold z is guaranteed to be less than the desired risk factor q. The threshold z can be extracted by applying the Pickands-Balkema-de Haan theorem using the peak over threshold (POT) technique to predict thresholds associated with risk factors so small that otherwise are difficult or impossible to estimate empirically, because their likelihood is such that they may have never been observed.

FIG. 1 is a block diagram illustrating an example computing device 100 for implementing aspects disclosed herein and is designated generally as computing device 100. Computing device 100 is but one example of a suitable computing environment and is not intended to suggest any limitation as to the scope of use or functionality of the examples disclosed herein. Neither should the computing device 100 be interpreted as having any dependency or requirement relating to any one or combination of components/modules illustrated.

The examples disclosed herein may be described in the general context of computer code or machine- or computer-executable instructions, such as program components, being executed by a computer or other machine. Program components include routines, programs, objects, components, data structures, and the like that refer to code, performs particular tasks, or implement particular abstract data types. The disclosed examples may be practiced in a variety of system configurations, including servers, personal computers, laptops, smart phones, servers, virtual machines (VMs), mobile tablets, hand-held devices, consumer electronics, specialty computing devices, etc. The disclosed examples may also be practiced in distributed computing environments when tasks are performed by remote-processing devices that are linked through a communications network.

The computing device 100 includes a bus 110 that directly or indirectly couples the following devices: computer-storage memory 112, one or more processors 114, one or more presentation components 116, I/O ports 118, I/O components 120, a power supply 122, and a network component 124. While the computing device 100 is depicted as a seemingly single device, multiple computing devices 100 may work together and share the depicted device resources. For example, memory 112 is distributed across multiple devices, and processor(s) 114 is housed with different devices. Bus 110 represents what may be one or more busses (such as an address bus, data bus, or a combination thereof). Although the various blocks of FIG. 1 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 1 and the references herein to a “computing device.”

Memory 112 may take the form of the computer-storage memory device referenced below and operatively provide storage of computer-readable instructions, data structures, program modules and other data for the computing device 100. In some examples, memory 112 stores one or more of an operating system (OS), a universal application platform, or other program modules and program data. Memory 112 is thus able to store and access data 112a and instructions 112b that are executable by processor 114 and configured to carry out the various operations disclosed herein. In some examples, memory 112 stores executable computer instructions for an OS and various software applications. The OS may be any OS designed to the control the functionality of the computing device 100.

By way of example and not limitation, computer readable media comprise computer-storage memory devices and communication media. Computer-storage memory devices may include volatile, nonvolatile, removable, non-removable, or other memory implemented in any method or technology for storage of information such as computer-readable instructions, data structures, program modules, or the like. Computer-storage memory devices are tangible and mutually exclusive to communication media. Computer-storage memory devices are implemented in hardware and exclude carrier waves and propagated signals. Computer-storage memory devices for purposes of this disclosure are not signals per se. Example computer-storage memory devices include hard disks, flash drives, solid state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number an organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device, CPU, GPU, ASIC, system on chip (SoC), or the like for provisioning new VMs when configured to execute the instructions described herein.

Processor(s) 114 may include any quantity of processing units that read data from various entities, such as memory 112 or I/O components 120. Specifically, processor(s) 114 are programmed to execute computer-executable instructions for implementing aspects of the disclosure. The instructions may be performed by the processor 114, by multiple processors 114 within the computing device 100, or by a processor external to the client computing device 100. In some examples, the processor(s) 114 are programmed to execute instructions such as those illustrated in the flow charts discussed below and depicted in the accompanying figures. Moreover, in some examples, the processor(s) 114 represent an implementation of analog techniques to perform the operations described herein. For example, the operations are performed by an analog client computing device 100 and/or a digital client computing device 100.

Presentation component(s) 116 present data indications to a user or other device. Example presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 100, across a wired connection, or in other ways. I/O ports 118 allow computing device 100 to be logically coupled to other devices including I/O components 120, some of which may be built in. Example I/O components 120 include, for example but without limitation, a microphone, joystick, game pad, satellite dish, scanner, printer, wireless device, etc.

The computing device 100 may communicate over a network 130 via network component 124 using logical connections to one or more remote computers. In some examples, the network component 124 includes a network interface card and/or computer-executable instructions (e.g., a driver) for operating the network interface card. Communication between the computing device 100 and other devices may occur using any protocol or mechanism over any wired or wireless connection. In some examples, network component 124 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 124 communicates over wireless communication link 126 and/or a wired communication link 126a across network 130 to a cloud environment 128. Various different examples of communication links 126 and 126a include a wireless connection, a wired connection, and/or a dedicated link, and in some examples, at least a portion is routed through the Internet.

The network 130 may include any computer network or combination thereof. Examples of computer networks configurable to operate as network 130 include, without limitation, a wireless network; landline; cable line; digital subscriber line (DSL): fiber-optic line; cellular network (e.g., 3G, 4G, 5G, etc.); local area network (LAN); wide area network (WAN); metropolitan area network (MAN); or the like. The network 130 is not limited, however, to connections coupling separate computer units. Rather, the network 130 may also include subsystems that transfer data between servers or computing devices. For example, the network 130 may also include a point-to-point connection, the Internet, an Ethernet, an electrical bus, a neural network, or other internal system. Such networking architectures are well known and need not be discussed at depth herein.

As described herein, the computing device 100 may be implemented as one or more servers. The computing device 100 may be implemented as a system 200 or in the system 200 as described in greater detail below.

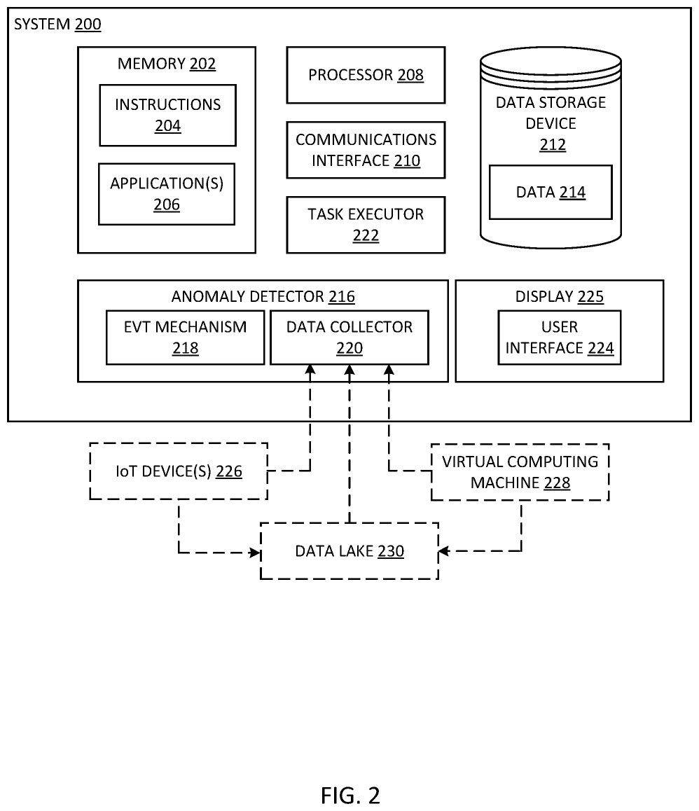

FIG. 2 is a block diagram illustrating an example system for implementing various examples of the present disclosure. The system 200 may include the computing device 100. In some implementations, the system 200 includes a cloud-implemented server that includes each of the components of the system 200 described herein. In some implementations, the system 200 is presented as a single computing device that contains each of the components of the system 200. In other implementations, the system 200 includes multiple devices.

The system 200 includes a memory 202, a processor 208, a communications interface 210, a data storage device 212, an anomaly detector 216, a task executor 222, and a user interface 224. The memory 202 stores instructions 204 executed by the processor 208 to control the communications interface 210, the anomaly detector 216, and the user interface 224. The memory 202 further stores data, such as one or more applications 206. An application 206 is a program designed to carry out a specific task on the system 200. For example, the applications 206 may include, but are not limited to, virtual computing applications, IoT device management applications, payment processing applications, drawing applications, paint applications, web browser applications, messaging applications, navigation/mapping applications, word processing applications, gaming applications, video applications, an application store, applications included in a suite of productivity applications such as calendar applications, instant messaging applications, document storage applications, video and/or audio call applications, and so forth, and specialized applications for a particular system 200. The applications 206 may communicate with counterpart applications or services, such as web services.

The processor 208 executes the instructions 204 stored on the memory 202 to perform various functions of the system 200. For example, the processor 208 controls the communications interface 210 to transmit and receive various signals and data, controls the data storage device 212 to store data 214, controls the anomaly detector 216 to detect anomalies in received data or data collected by the system 200, and controls the user interface 224.

The data storage device 212 stores data 214. The data 214 may include any data, including data collected by a data collector 220 implemented on the anomaly detector 216. For example, the data 214 may be data captured by an IoT device 226 or a virtual computing machine 228 that is collected by the data collector 220 for analysis. In some examples, the data 214 is input data comprising a number of samples, n. The input data 214 may be defined as S={s_1, s_2, . . . , s_n}. Each feature of data, s, comprises a number of features, k. which is expressed as s_i={f_1, f_2, . . . , f_k}.

The anomaly detector 216 is implemented on the processor 208 and includes an EVT mechanism 218 and the data collector 220. The EVT mechanism 218 is a specialized processing unit that executes a machine learning (ML) model or algorithm to perform one or more calculations described herein to calculate a probability value, calculate a threshold, and assign an outlier score based on the calculated probability value and threshold. The probability value and threshold are calculated for a sample of data 214 collected by the data collector 220.

The EVT mechanism 218 calculates probability value and the threshold for features in a sample set of the input data 214. For example, the EVT mechanism 218 selects a random number of observations, or features, of the input data 214 identified as S={s_1, s_2, . . . , s_n}. The random number of observations are defined a n_init for each feature as a calibration set C. Given the risk factor q, which may be defined by a user, the EVT mechanism 218 extracts the threshold z such that the probability of any sample s in the input data 214 to exceed the threshold z is less than the desired risk factor q. In other words Prob(s<=z)<=q. The threshold z is extracted by fitting the tail of the calibration set C to a Generalized Pareto Distribution (GPD) parametrized by two parameters sigma σ and gamma γ. The sigma σ and gamma γ parameters are learned from the calibration dataset C. Upon the sigma σ and gamma γ parameters being learned, an invertible non-linear relationship is identified between the threshold z and the risk factor q. Thus, instead of using a known risk factor and inferring a threshold, the EVT mechanism 218 instead uses the extracted threshold value z to calculate the risk factor q for each feature in the calibration set C.

Therefore, for every feature in the calibration set C, all remaining samples S={s_1, . . . , s_n} are used as threshold values z which are used to determine the relevant risk factor q. For example, for a sample s_i that has feature values (f_1, f_2, f_3, . . . , f_k), the EVT mechanism 218 calculates a series of threshold values, namely (z_i_1, z_i_2, . . . , z_i_k), for each feature in the sample s_i. Because the risk factor q can be interpreted as real mathematical probability, the value of each risk factor q is used as an outlier score, such that the probability associated with feature j of sample s_i as extracted by the EVT mechanism 218. This relationship is shown by Equation 1, which states the outlier score associated with feature j of sample s_i is equal to log(1/q_i_j).

a_i_j=log(1/q_i_j) Equation 1

An overall score for the sample i is provided as the sum of each outlier score a_i_j for all j features.

The EVT mechanism 218 performs these operations to learn the sigma σ and gamma γ parameters and calculate the risk factor q using an equation that measures a final threshold z_{q} as approximately equal to the desired probability, or desired risk factor, q multiplied by the total number of observations n over the number of peaks Nₜ in the dataset, all raised to the power of negative gamma γ, minus one, multiplied by a proportion of parameters sigma σ and gamma γ, plus the initial threshold t. This equation is provided as Equation 2 below.

$${z}_{q} ≃ t + \frac{σ}{γ} ( {( \frac{qn}{{N}_{t}} )}^{- γ} - 1 ) \qquad Equation 2$$

Ultimately, the risk factor q is extracted for each data point, or feature, in the input data 214 and compared to the extracted threshold. For data points that have a value above the threshold t, a risk factor q is extracted, tagged as a potential outlier, and an outlier score is assigned as log(1/q). In some examples, an outlier score above a threshold level triggers a task, or action, to be executed. Triggered tasks are executed by the task executor 222, described in greater detail below.

The properties and principles performed by the EVT mechanism 218 are based on a convergence property of the tail of probability density functions captured by the 2nd fundamental theorem of extreme value statistics, the Pickands-Balkema-de Haan theorem. The EVT mechanism 218 applies the Pickands-Balkema-de Haan theorem using a peak over threshold (POT) technique to extract the threshold z, which accurately predicts thresholds associated with very small risk factors q<<1 that otherwise cannot be estimated empirically. As referenced herein, a small risk factor is an event so rare that it may never have been observed in the past.

The task executor 222 is implemented on the processor 208 and executes the triggered task based on the outlier score being above the threshold level. In examples where the system 200 is an engineering system for one or more IoT devices 226 that detects an anomaly in an IoT device 226, the outlier score may indicate that a particular device has failed or is susceptible to failing and the triggered action is to initiate repair or replacement of the IoT device 226. In examples where the system 200 is a virtual computing machine 228 for a payment system, the outlier score may indicate an order of an unusual size or from an unusual account and the triggered action is to flag the order as potentially fraudulent and either decline to process the order or investigate the order prior to fulfillment.

The user interface 224 may be presented on a display, such as the display 225, of the system 200. The user interface 224 may present status updates including data points identified as outliers, all data points, calculated thresholds, triggered actions to be taken, triggered actions that have been taken, and so forth.

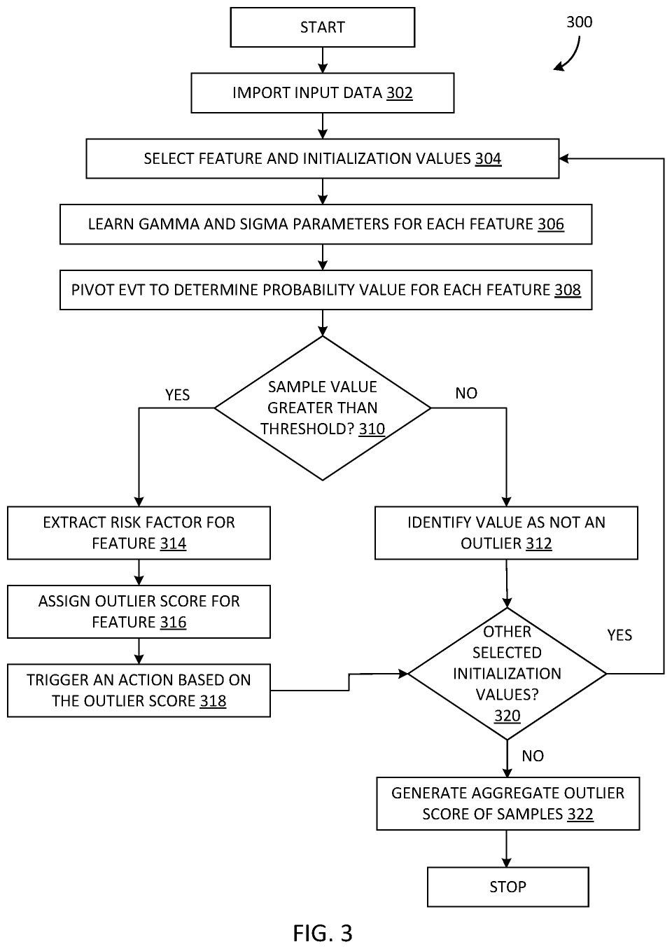

FIG. 3 is a flow chart illustrating a computer-implemented method of defining an outlier score according to various examples of the present disclosure. The operations illustrated in FIG. 3 are for illustration and should not be construed as limiting. Various examples of the operations may be used without departing from the scope of the present disclosure. The operations of the method 300 illustrated in the flow chart of FIG. 3 may be executed by one or more components of the system 200, including the processor 208, the anomaly detector 216 including the EVT mechanism 218 and the data collector 220, and the task executor 222.

The method 300 begins by the data collector 220 importing, or retrieving, input data in operation 302. In some examples, the received input data 214 is defined as S={s_1, s_2, . . . , s_n}. In some examples, the input data is data from one or more sources and stored in the data storage device 212 as the input data 214 described herein. In some examples, the data collector 220 imports data from a data lake 230 that stores data. The data lake 230 may store data from the one or more IoT devices 226, one or more virtual computing machines 228, and/or additional data sources.

In some examples, the data collector 220 imports the data directly from the one or more IoT devices 226, one or more virtual computing machines 228, and/or additional data sources. In some examples, the input data 214 is received in real-time from the one or more sources. For example, where the data collector 220 collects data related to video or audio streaming, the input data 214 is streaming data received in real-time. In another example, where the data collector 220 collects data from one or more IoT devices 226, the input data 214 is data captured by one or more sensors of the one or more IoT devices 226 in real time.

In operation 304, the EVT mechanism 218 selects feature values f_i and an initialized set of the imported input data 214. In some examples, the initialized set of the received input data 214 is a subset of the imported data. Each feature of the selected input data 214 comprises a number of features, k. which is expressed as s_i={f_1, f_2, . . . , f_k}. The initialized set of the received input data 214 is defined as n_init, as described herein. The EVT mechanism 218 may select the initialized set of the received input data 214 based on various factors. In some examples, the initialized set of the received input data 214 is selected randomly. In some examples, the initialized set of the received input data 214 is selected based on the most recent data points received. In some examples, the initialized set of the received input data 214 is updated on an ad-hoc basis with new samples that have been confirmed as anomalies. The new samples may be confirmed by via an external mechanism, by previous iterations of the method 300, and so forth.

In operation 306, the EVT mechanism 218 learns the sigma σ and gamma γ parameters of each selected feature k of the initialized set of collected input data 214 using Equation 2. In some examples, the sigma σ and gamma γ parameters are learned using a method of moments technique, a probability weighted moments technique, by optimizing a Generalized Pareto Distribution (GPD) on the calibration set C, or any other suitable methods.

In operation 308, the EVT mechanism 218 pivots the values of Equation 2 to determine the probability value for each feature k based on the relationship between the threshold and the risk factor q using the learned sigma σ and gamma γ parameters. For example, once the sigma σ and gamma γ parameters are learned, each of the other values, including the sample value z, are inserted into Equation 2 to solve for the risk factor q. In some examples, the EVT mechanism extracts a risk factor q_i for each feature, which is the selected initialized set of the received input data 214 based on the relationship between the threshold and the risk factor q.

In operation 310, for each feature k, the EVT mechanism 218 determines whether the sample value is greater than the determined threshold. Where the sample value is not greater than the threshold, the EVT mechanism 218 identifies the value as not an outlier, or anomaly, in operation 312. Where the sample value is determined to be greater than the threshold, the EVT mechanism extracts the risk factor q for the feature k in operation 314 by solving for the risk factor q in Equation 2. In operation 316, based on the extracted risk factor q, the EVT mechanism assigns as outlier score for the feature using Equation 1.

In operation 318, the task executor 222 executes an action based on the defined outlier score. In examples where the system 200 is an engineering system for one or more IoT devices 226 that detects an anomaly in an IoT device 226, the outlier score may indicate that a particular device has failed or is susceptible to failing and the triggered action is to initiate repair or replacement of the IoT device 226. In examples where the system 200 is a virtual computing machine 228 for a payment system, the outlier score may indicate an order of an unusual size or from an unusual account and the triggered action is to flag the order as potentially fraudulent and either decline to process the order or investigate the order prior to fulfillment. In examples where the system 200 is a virtual storage system, the outlier score may indicate data being stored in an unusual location and the triggered action is to flag the stored data as potentially fraudulent.

In operation 320, the EVT mechanism 218 determines whether additional selected initialization values n_init are ready for analysis. The additional selected initialization values n_init may be additional data stored in the data lake 230 that is ready for import by the data collector 220. In examples where additional selected initialization values n_init are ready for analysis, the method 300 returns to operation 304 and selects the additional selected initialization values n_init. The EVT mechanism and task executor 222 then proceed through operations 304-320 until, in operation 320, no additional initialization values n_init are determined to be ready for analysis.

In operation 322, the EVT mechanism 218 generates an aggregate outlier score of the samples s_i in the input data 214. In other words, the EVT mechanism 218 generates a singular score that quantifies the outlier scores for the input data 214. Each sample s_i is assigned outlier scores using Equation 1, in which the outlier score is equal to log (1/q_i). For example, the first outlier score is assigned as log(1/q_i_1), the second outlier score is assigned as log(1/q_i_2), and so forth through the final outlier score log(1/q_i_k). The sum of the outlier scores are prepared as an aggregate outlier score of the sample s_i.

In some examples, the generated aggregate outlier score is presented on the user interface 224 as a notification or alert to a user. In some examples, the generated aggregate outlier score triggers an additional action, in addition to the action triggered and executed in operation 318. For example, different tasks may be triggered based on the intensity of the outlier score and/or the aggregate outlier score. An outlier score above a first threshold but below a second threshold may trigger a first action, while an outlier score above the second threshold may trigger a second, strong action. In the example above where the system 200 is a virtual storage system, an outlier score above the first threshold but below the second threshold triggers a first action to investigate the circumstances surrounding the data stored in the unusual location, while an outlier score above the second threshold triggers a second action to take the unusual storage location offline in case of fraud. Accordingly, the task executor 222 may executes different actions based on the intensity, or degree, of the outlier score and/or the aggregate outlier score.

In some examples, discrepancies between a single outlier score and the aggregate outlier score may trigger a second action. In the above example where the system 200 is an engineering system for one or more IoT devices 226, a single elevated outlier score may be likely to indicate a failure or likelihood of failure in a single IoT device 226. However, an elevated aggregate outlier score may indicate a more widespread issue than a single IoT device 226. Thus, while a single elevated outlier score may trigger an action such as a repair or replacement of a single IoT device 226, the elevated aggregate outlier score may trigger a more comprehensive investigation or shut down of a network on which a plurality of IoT devices 226 communicate because the anomaly appears to be more widespread than with a single IoT device 226.

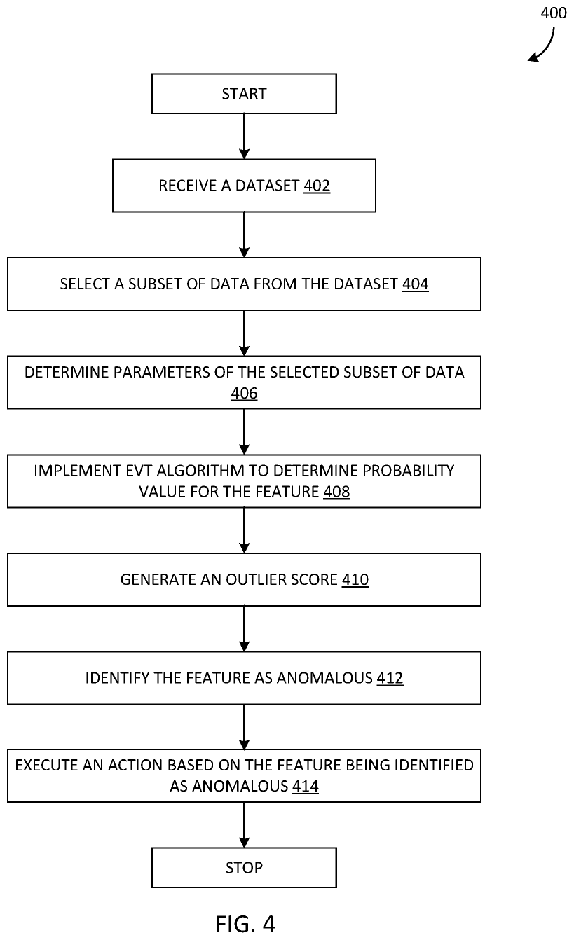

FIG. 4 is a flow chart illustrating a computer-implemented method of defining an outlier score according to various examples of the present disclosure. The operations illustrated in FIG. 4 are for illustration and should not be construed as limiting. Various examples of the operations may be used without departing from the scope of the present disclosure. The operations of the method 400 illustrated in the flow chart of FIG. 4 may be executed by one or more components of the system 200, including the processor 208, the anomaly detector 216 including the EVT mechanism 218 and the data collector 220, and the task executor 222.

The method 400 begins by the data collector 220 receiving, or collecting, a dataset in operation 402. The dataset may be received from one or more sources, such as one or more IoT devices 226, one or more virtual computing machines 228, and the data lake 230, and stored in the data storage device 212 as the input data 214. In some examples, the dataset is the received input data 214 defined as S={s_1, s_2, . . . , s_n}.

In operation 404, the EVT mechanism 218 selects a subset of data 214 from the dataset. The subset may be the initialized set of the imported input data 214. Each feature of the selected input data 214 comprises a plurality of features, k. which is expressed as s_i={f_1, f_2, . . . , f_k}. The initialized set of the received input data 214 is defined as n_init, as described herein. The subset of data may be selected based on various factors. For example, the subset of data may be randomly selected, the subset may be selected as the most recent data received, and so forth.

In operation 406, the EVT mechanism 218 determines parameters of the selected subset of data. In some examples, the determined parameters are a gamma value and a sigma value of a tail of a calibration set of data. In operation 408, the EVT mechanism 218 implements and pivots the values of the EVT algorithm to determine the probability value for each feature k. In some examples, the EVT mechanism 218 further implements the EVT algorithm to determine a threshold for anomalous features. In some examples, the probability value is determined based on the relationship between the threshold and the risk factor q using the learned sigma σ and gamma γ parameters.

In operation 410, the EVT mechanism 218 generates an outlier score for the feature. In operation 412, the EVT mechanism 218 identifies the feature as anomalous based at least in part on the generated outlier score. For example, the feature may be determined to be anomalous based at least in part on the generated outlier score being greater than the determined threshold. In contrast, a feature having a determined probability value not greater than the determined threshold is not determined to be anomalous.

In operation 414, the task executor 222 executes an action based on the feature being identified as anomalous. As described herein, the executed action depends on the type of engineering system 200 performing the method 400. In examples where the system 200 is an engineering system for one or more IoT devices 226 that detects an anomaly in an IoT device 226, the outlier score may indicate that a particular device has failed or is susceptible to failing and the triggered action is to initiate repair or replacement of the IoT device 226. In examples where the system 200 is a virtual computing machine 228 for a payment system, the outlier score may indicate an order of an unusual size or from an unusual account and the triggered action is to flag the order as potentially fraudulent and either decline to process the order or investigate the order prior to fulfillment. In examples where the system 200 is a virtual storage system, the outlier score may indicate data being stored in an unusual location and the triggered action is to flag the stored data as potentially fraudulent.

In some examples, the method 400 is performed in real-time. The dataset may be received, a subset of data selected, parameters determined, the probability value and threshold determined, the feature identified as anomalous, and an action executed in real-time. In other examples, the method 400 is performed in stages and not in real-time. For example, the data may be received or stored for a period of time before a subset of the data is selected and a probability determined.

In some examples, the method 400 is performed for each feature in the selected subset of data 214. In other words, the operations of the method 400 may be performed for multiple features at a time. The subset of data may include a plurality of features, a probability value for each feature in the plurality of features may be determined, at least one feature of the plurality of features may be identified as anomalous based on the determined probability value for the identified at least one feature, an outlier score may be determined for the at least one identified feature, and an action may be executed based on the identified at least one feature being identified as anomalous.

In examples where the method 400 is performed for multiple features at a time, an aggregated outlier score may be generated for the subset of data. The aggregate outlier score includes a sum of the generated outlier scores for each of the plurality of features.

### Additional Examples

Some examples herein are directed to a method that uses extreme value theory (EVT) to determine an anomalous feature in a dataset. The method (400) includes receiving (402) a dataset, selecting (404) a subset of data from the dataset, the subset including a feature, determining (406) parameters of the selected subset of data, implementing (408) an extreme value theory (EVT) algorithm to determine a probability value for the feature based at least in part on the determined parameters, and in response to identifying the feature as anomalous, generating (410) an outlier score for the feature.

In some examples, the method further comprises identifying (412) the subset as anomalous based at least in part on the generated outlier score for the feature.

In some examples, the subset includes a plurality of features, and the method further comprises implementing the EVT algorithm to determine a probability value for each of the plurality of features, generating an outlier score for each of the plurality of features, and generating an aggregate outlier score for the subset, the aggregate outlier score comprising a sum of the generated outlier scores for each of the plurality of features.

In some examples, the method further comprises executing (414) an action based on the generated outlier score.

In some examples, the determined parameters are a gamma value and a sigma value of a tail of a calibration set of data.

In some examples, the method further comprises implementing the EVT algorithm to determine a threshold for anomalous features.

In some examples, the method further comprises identifying the subset as anomalous based at least in part on the generated outlier score for the feature being greater than the determined threshold.

In some examples, the method further comprises identifying the subset as anomalous in real-time.

Some examples herein are directed to a system that uses extreme value theory (EVT) to determine an anomalous feature in a dataset. The system (200) includes a processor (208), a memory (202) storing instruction (204) executable by the processor, a data collector (220), implemented on the processor, that receives a dataset, an extreme value theory (EVT) mechanism (218), implemented on the processor, that selects a subset of data from the dataset, the subset including a feature, determines parameters of the selected subset of data, implements an extreme value theory (EVT) algorithm to determine a probability value for the feature based at least in part on the determined parameters, in response to the determined probability value for the feature, generates an outlier score for the feature, and identifies the subset as anomalous based at least in part on the generated outlier score for the feature, and a task executor (222), implemented on the processor, that executes an action based on the subset being identified as anomalous.

Some examples herein are directed to one or more computer-storage memory devices (202) embodied with executable instructions (204) that, when executed by a processor (208), cause the processor to receive, by a data collector (220) implemented on the processor, a dataset, select, by an extreme value theory (EVT) mechanism (218) implemented on the processor, a subset of data from the dataset, the subset including a plurality of features, determine, by the EVT mechanism implemented on the processor, parameters of the selected subset of data, implement, by the EVT mechanism implemented on the processor, an EVT algorithm to determine a probability value for each feature of the plurality of features based at least in part on the determined parameters, generate, by the EVT mechanism implemented on the processor, an outlier score for the identified feature, identify, by the EVT mechanism implemented on the processor, the subset as anomalous based at least in part on the generated outlier score for the identified feature, in response to identifying the feature as anomalous, and execute, by a task executor implemented on the processor, an action based on the subset being identified as anomalous.

Although described in connection with an example computing device 100 and system 200, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, servers, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality (MR) devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable, and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one example or may relate to several examples. The examples are not limited to those that solve any or all of the stated problems or those that have any or all of the stated benefits and advantages. It will further be understood that reference to ‘an’ item refers to one or more of those items.

The term “comprising” is used in this specification to mean including the feature(s) or act(s) followed thereafter, without excluding the presence of one or more additional features or acts.

In some examples, the operations illustrated in the figures may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

What is claimed is:

1. A computer-implemented method, comprising:
receiving a dataset;
selecting a subset of data from the dataset, the subset including a feature;
determining parameters of the selected subset of data;
implementing an extreme value theory (EVT) algorithm to determine a probability value for the feature based at least in part on the determined parameters; and
in response to identifying the feature as anomalous, generating an outlier score for the feature.

2. The computer-implemented method of claim 1, further comprising:
identifying the subset as anomalous based at least in part on the generated outlier score for the feature.

3. The computer-implemented method of claim 2, wherein:
the subset includes a plurality of features, and
the computer-implemented method further comprises:
implementing the EVT algorithm to determine a probability value for each of the plurality of features,
generating an outlier score for each of the plurality of features, and
generating an aggregate outlier score for the subset, the aggregate outlier score comprising a sum of the generated outlier scores for each of the plurality of features.

4. The computer-implemented method of claim 2, further comprising:
executing an action based on the generated outlier score.

5. The computer-implemented method of claim 1, wherein the determined parameters are a gamma value and a sigma value of a tail of a calibration set of data.

6. The computer-implemented method of claim 1, further comprising:
implementing the EVT algorithm to determine a threshold for anomalous features.

7. The computer-implemented method of claim 6, further comprising:
identifying the subset as anomalous based at least in part on the generated outlier score for the feature being greater than the determined threshold.

8. The computer-implemented method of claim 1, further comprising:
identifying the subset as anomalous in real-time.

9. A system, comprising:
a processor;
a memory storing instructions executable by the processor;
a data collector, implemented on the processor, that receives a dataset;
an extreme value theory (EVT) mechanism, implemented on the processor, that:
selects a subset of data from the dataset, the subset including a feature,
determines parameters of the selected subset of data,
implements an extreme value theory (EVT) algorithm to determine a probability value for the feature based at least in part on the determined parameters,
in response to the determined probability value for the feature, generates an outlier score for the feature, and
identifies the subset as anomalous based at least in part on the generated outlier score for the feature; and
a task executor, implemented on the processor, that executes an action based on the subset being identified as anomalous.

10. The system of claim 9, wherein:
the subset includes a plurality of features, and
the EVT mechanism further:
implements the EVT algorithm to determine a probability value for each of the plurality of features,
generates an outlier score for each of the plurality of features.

11. The system of claim 10, wherein the EVT mechanism further generates an aggregate outlier score for the subset, the aggregate outlier score comprising a sum of the generated outlier scores for each of the plurality of features.

12. The system of claim 9, wherein the determined parameters are a gamma value and a sigma value of a tail of a calibration set of data.

13. The system of claim 9, wherein the EVT mechanism further implements the EVT algorithm to determine a threshold for anomalous features.

14. The system of claim 13, wherein the EVT mechanism further identifies the subset as anomalous based at least in part on the generated outlier score for the feature being greater than the determined threshold.

15. The system of claim 9, wherein the EVT mechanism further identifies the subset as anomalous in real-time.

16. One or more computer-storage memory devices embodied with executable instructions that, when executed by a processor, cause the processor to:
receive, by a data collector implemented on the processor, a dataset;
select, by an extreme value theory (EVT) mechanism implemented on the processor, a subset of data from the dataset, the subset including a plurality of features;
determine, by the EVT mechanism implemented on the processor, parameters of the selected subset of data;
implement, by the EVT mechanism implemented on the processor, an EVT algorithm to determine a probability value for each feature of the plurality of features based at least in part on the determined parameters;
generate, by the EVT mechanism implemented on the processor, an outlier score for each feature of the plurality of features;
identify, by the EVT mechanism implemented on the processor, the subset as anomalous based at least in part on the generated outlier score for at least one feature of the plurality of features; and
execute, by a task executor implemented on the processor, an action based on the subset being identified as anomalous.

17. The one or more computer-storage memory devices of claim 16, further embodied with instructions that, when executed by the processor, cause the processor to:
implement, by the EVT mechanism, the EVT algorithm to determine a probability value for each of the plurality of features,
generate, by the EVT mechanism, an outlier score for each of the plurality of features, and
generate, by the EVT mechanism, an aggregate outlier score for the subset, the aggregate outlier score comprising a sum of the generated outlier scores for each of the plurality of features.

18. The one or more computer-storage memory devices of claim 16, wherein the determined parameters are a gamma value and a sigma value of a tail of a calibration set of data.

19. The one or more computer-storage memory devices of claim 16, further embodied with instructions that, when executed by the processor, cause the processor to:
determine, by the EVT mechanism, a threshold for anomalous features.

20. The one or more computer-storage memory devices of claim 19, further embodied with instructions that, when executed by the processor, cause the processor to:
identify, by the EVT mechanism, the subset as anomalous based at least in part on the determined probability value for the feature being greater than the determined threshold.
